(19) United States
(12) Patent Application Publication
(10) Pub. No.: US 2025/0180838 A1
(43) Pub. Date: Jun. 5, 2025

(54) FILM-COATED OPTICAL FIBER PHOTOVOLTAIC CONVERSION MODULE BASED ON MULTI-CHIP PACKAGE TECHNOLOGY

(71) Applicant: Shenzhen 8k Link Optoelectronics Technology Co., Ltd., Shenzhen (CN)

(72) Inventors: Xinghui JIN, Shenzhen (CN); Yang LI, Shenzhen (CN)

(73) Assignee: Shenzhen 8k Link Optoelectronics Technology Co., Ltd., Shenzhen (CN)

(21) Appl. No.: 18/526,902

(22) Filed: Dec. 1, 2023

(51) Int. Cl. G02B 6/42; G02B 6/43

(52) U.S. Cl. CPC G02B 6/428; G02B 6/421; G02B 6/4237; G02B 6/43

(57) ABSTRACT

A film-coated optical fiber photovoltaic conversion module includes a multi-chip package, laser welding spots, a PCBA, film-coated optical fibers, coatings, lasers, and gratings. The multi-chip package is fixedly connected to a top portion of the PCBA; the multi-chip package is provided with a metal bonding pad allowing welding of the lasers; the metal bonding pad is further provided with the laser welding spots; and the coatings are coated outside the film-coated optical fibers. The film-coated optical fiber photovoltaic conversion module based on the multi-chip package technology combines the multi-chip package with the film-coated optical fibers to omit a conventional COB process; a structure design is reasonable such that the film-coated optical fibers disposed at a 45° bevel is docked with the Vcsel lasers to allow direct refraction of light into the optical fibers.

### TECHNICAL FIELD

The application relates to the photovoltaic conversion technology, and in particular, to a film-coated optical fiber photovoltaic conversion module based on a multi-chip package technology.

### BACKGROUND

In the field of communication, electrical interconnection transmission based on metal wires is greatly limited due to factors such as electromagnetic interference, inter-symbol interference and loss and wiring cost, which consequently gives rise to optical transmission having advantages such as high bandwidth, large capacity, easy integration, low loss, good electromagnetic compatibility, no crosstalk, light weight and small size. Hence, the optical transmission is widely applied to digital signal transmission. As a core device in the optical fiber transmission, an optical module determines the overall performance of transmission by virtue of its various indicators. The optical module is a carrier for transmission between a switch and an apparatus, and mainly functions to convert electrical signals from the apparatus into optical signals by an emitter. Its basic structure consists of two parts, including “an optical emission assembly and a drive circuit thereof” and “an optical receiving assembly and a receiving circuit thereof”. The optical module includes two channels, namely an emission channel and a receiving channel.

For an existing photovoltaic conversion module that is put into use, an optical module structure and a process matched therewith are complex with numerous components, and need to be processed and completed using a high-precision optical coupling system. Optical and electrical channels are implemented by optical fibers and cables, respectively. The wires and cables have a complex sectional structure and cannot be further reduced in diameter and weight, leading to relatively high cost. The hybrid structure consisting of optical fibers and copper wires is not conducive to wire processing or the like.

### SUMMARY

One object of the application is to provide a film-coated optical fiber photovoltaic conversion module based on a multi-chip package technology, in order to overcome the above defects in the prior art.

To achieve the above object, the application provides the following technical solution: a film-coated optical fiber photovoltaic conversion module based on a multi-chip package technology, including a multi-chip package, laser welding spots, a printed circuit board assembly (PCBA), film-coated optical fibers, coatings, lasers, and gratings, wherein the multi-chip package is fixedly connected to a top portion of the PCBA; the multi-chip package is provided with a metal bonding pad allowing welding of the lasers; the metal bonding pad is also provided with the laser welding spots; the coatings are coated outside the film-coated optical fibers; the lasers are fixedly connected to the multi-chip package by means of the metal bonding pad; one side of each of the film-coated optical fibers extends to be provided with an inclined bevel; the film-coated optical fibers and the multi-chip package are fixedly connected by means of the laser welding spots; and one end of each of the film-coated optical fibers is provided with the grating.

Further, the lasers are Vcsel lasers.

Further, the bevel is disposed at 45° with respect to a plane at a top portion of the multi-chip package.

Further, the coatings are metal coatings and are welded to the multi-chip package by means of the laser welding spots.

Further, output ends of the lasers point to the bevels.

Further, the gratings are etched in bevel ends of the film-coated optical fibers by means of an etching technology, and are above the lasers.

Compared with the prior art, the application provides the film-coated optical fiber photovoltaic conversion module based on the multi-chip package technology, which combines the multi-chip package with the film-coated optical fibers to omit a conventional COB process, such that products can be standardized and produced in mass; a structure design is reasonable such that the film-coated optical fibers disposed at a 45° bevel are docked with the Vcsel lasers to allow direct refraction of light into the optical fibers, which omits an optical article jumper; and the metal coatings can be disposed to serve as power cords to supply power to the module, which omits the wire bonding for the conventional copper wires, allowing the photovoltaic conversion module to become more lightweight.

### BRIEF DESCRIPTION OF THE DRAWINGS

To describe the technical solutions in the embodiments of the application or in the prior art more clearly, the following briefly introduces the accompanying drawings to be used in the embodiments. Obviously, the accompanying drawings in the following description only shows some embodiments stated in the disclosure, and those of ordinary skill in the art can still derive other drawings from these accompanying drawings without creative effort.

FIG. 1 is a schematic diagram showing an overall structure according to an embodiment of the application.

FIG. 2 is a schematic diagram showing, in a side view, a structure according to an embodiment of the application.

FIG. 3 is a schematic diagram showing, in a top view, a structure according to an embodiment of the application.

### DETAILED DESCRIPTION OF THE EMBODIMENTS

To allow those of ordinary skill in the art to have a better understanding of the technical solutions of the application, the following will further introduce the application in detail in conjunction with the accompanying drawings.

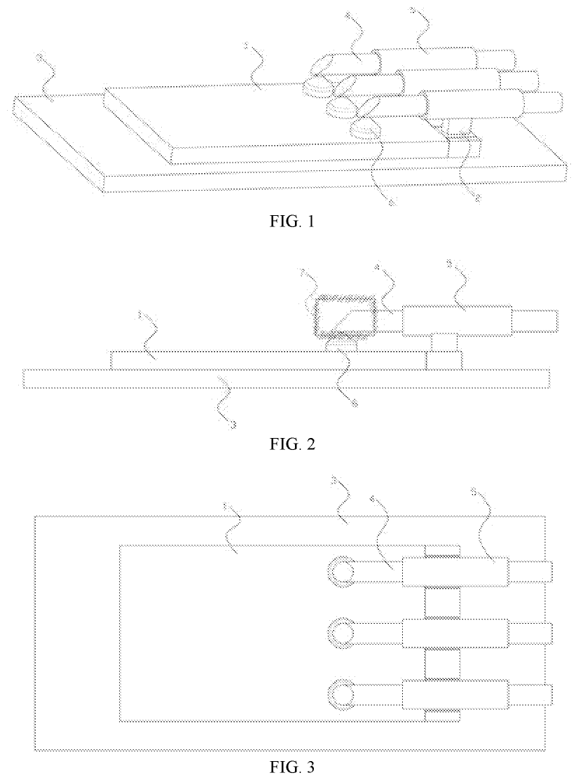

Referring to FIGS. 1-3, a film-coated optical fiber photovoltaic conversion module based on a multi-chip package technology includes a multi-chip package 1, laser welding spots 2, a PCBA 3, film-coated optical fibers 4, coatings 5, lasers 6, and gratings 7. The multi-chip package 1 is fixedly connected to a top portion of the PCBA 3; and the multi-chip package 1 is provided with a metal bonding pad allowing welding of the lasers 6. In such a configuration, the circuits can be linked while a location reference is provided to the optical fibers, such that the conventional wire bonding process is omitted, and the structure is greatly optimized. The metal bonding pad is also provided with laser welding spots 2; the coatings 5 are coated outside the film-coated optical fibers 4; the lasers are fixedly connected to the multi-chip package 1 by means of the metal bonding pad; one side of each of the film-coated optical fibers 4 extends to be provided with an inclined bevel; the film-coated optical fibers 4 and the multi-chip package 1 are fixedly connected by means of the laser welding spots 2; and one end of each of the film-coated optical fibers 4 is provided with the grating 7. Meanwhile, the multi-chip package 1 is based on the multi-chip package technology instead of the conventional COB process, such that die bonding and wire bonding are omitted, thereby saving the process time and allowing rapid switching of products to facilitate the production.

The lasers 6 are Vcsel lasers.

The bevel is disposed at 45° with respect to the plane at the top portion of the multi-chip package 1. In such a configuration, the top portion of each optical fiber is beveled at 45°, and light can be refracted into the optical fiber by means of the bevel of 45°, such that the conventional coupling process can be omitted.

The coatings 5 are metal coatings and are welded to the multi-chip package 1 by means of the laser welding spots 2. In such a configuration, the metal coatings 5 are disposed not only to protect the optical fibers to make them firmer and more flexible, but also to endow the optical fibers with properties of conduction and power supply, such that the wire bonding for conventional copper wires is omitted; and the processing precision of high-precision laser welding or ultrasonic welding can reach a micron level, and metal welding and fixing can allow extremely high stability, such that an aging allowance does not need to be reserved for a later stage during processing. Therefore, the precision required for connecting optical circuits can be met easily.

Output ends of the lasers 6 point to the bevels. In such a configuration, light can be refracted into the optical fibers directly by means of the bevel of 45°, such that an optical article jumper can be omitted to save the cost.

The gratings 7 are etched in the bevel ends of the film-coated optical fibers 4 by an etching technology and are above the lasers 6. In such a configuration, light can be refracted directly by means of the gratings.

Working principle: When in use, the multi-chip package and the film-coated optical fibers are combined to omit the conventional COB process, such that products can be standardized and produced in mass. The structural design is reasonable such that the optical fiber with the bevel of 45° is docked with the Vcsel lasers to allow direct refraction of the light into the optical fibers, and an optical article jumper can be omitted. The metal protecting the optical fiber can act as a power cord to supply power to the module, such that the wire bonding for conventional copper wires is omitted, allowing the photovoltaic conversion module to become more lightweight.

The above describes some exemplary embodiments of the application only in an illustrative way. Those skilled in the art can make amendments to the described embodiments in a variety of different ways without departing from the spirit and scope of the application. Therefore, the above drawings and description are illustrative in essence, and should not be understood as limiting the protection scope of the claims of the application.

1. A film-coated optical fiber photovoltaic conversion module based on a multi-chip package technology, comprising a multi-chip package, laser welding spots, a printed circuit board assembly (PCBA), film-coated optical fibers, coatings, lasers, and gratings, wherein
the multi-chip package is fixedly connected to a top portion of the PCBA; the multi-chip package is provided with a metal bonding pad, which is also provided with the laser welding spots; one side of each of the film-coated optical fibers extends to be provided with an extension end, which is provided with an inclined bevel; the film-coated optical fibers and the multi-chip package are fixedly connected by means of the laser welding spots; and one end of each of the film-coated optical fibers is provided with the grating.

2. The film-coated optical fiber photovoltaic conversion module based on the multi-chip package technology according to claim 1, wherein the lasers are fixedly connected to the multi-chip package by means of the metal bonding pad, and the lasers are Vcsel lasers.

3. The film-coated optical fiber photovoltaic conversion module based on the multi-chip package technology according to claim 1, wherein the bevels are disposed at 45° with respect to a plane at a top portion of the multi-chip package.

4. The film-coated optical fiber photovoltaic conversion module based on the multi-chip package technology according to claim 1, wherein the coatings are metal coatings and are coated outside the film-coated optical fibers, and the coatings are welded to the multi-chip package by means of the laser welding spots.

5. The film-coated optical fiber photovoltaic conversion module based on the multi-chip package technology according to claim 1, wherein output ends of the lasers point to the bevels.

6. The film-coated optical fiber photovoltaic conversion module based on the multi-chip package technology according to claim 1, wherein the gratings are etched in bevel ends of the film-coated optical fibers by means of an etching technology, and are above the lasers.
